(19) United States
(12) Patent Application Publication
(10) Pub. No.: US 2018/0283623 A1
(43) Pub. Date: Oct. 4, 2018

(54) MULTI-FUNCTIONAL PHOSPHORESCENT LIGHTING DEVICES

(71) Applicant: Aixia Bian, Shanghai (CN)

(72) Inventor: Aixia Bian, Shanghai (CN)

(21) Appl. No.: 15/801,489

(22) Filed: Nov. 2, 2017

Related U.S. Application Data
(63) Continuation of application No. 15/475,658, filed on Mar. 31, 2017.
Application No. 15/475,658 is a continuation of application No. 15/581,848, filed on Apr. 28, 2017.
Application No. 15/581,848 is a continuation of application No. 15/581,863, filed on Apr. 28, 2017.
Application No. 15/581,863 is a continuation of application No. 15/640,706, filed on Jul. 3, 2017.
Application No. 15/640,706 is a continuation of application No. 15/640,700, filed on Jul. 3, 2017.

(51) Int. Cl. F21L 4/02; F21V 23/04; F21V 21/08; F21L 4/08

(52) U.S. Cl. CPC F21L 4/02; F21V 23/0414; F21Y 2115/10; F21L 4/08; F21V 21/08

(57) ABSTRACT

The lighting device disclosed includes a lighting element positioned in a housing and a battery system coupled to an inside of the housing and operably connected to and enabling the lighting element to emit light. The lighting device includes a first phosphorescent element which is positioned to absorb light from an ambient light source, the lighting element, or both. The first phosphorescent element therefore enables the lighting device to be located in dark.

### REFERENCE TO RELATED APPLICATIONS

The present application claims priority to U.S. application Ser. No. 15/581,863, filed on Apr. 28, 2017; U.S. application Ser. No. 15/581,848, filed on Apr. 28, 2017; U.S. application Ser. No. 15/475,658, filed on Mar. 31, 2017; U.S. application Ser. No. 15/640,706, filed on Jul. 3, 2017; and U.S. application Ser. No. 15/640,700, filed on Jul. 3, 2017, the contents of all of which are incorporated herein by reference in their entirety.

### FIELD OF THE INVENTION

The present description relates generally to portable lighting devices used for illuminating spaces.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Portable lanterns and the like are used in a variety of situations. Some are used for area illumination in spaces without dedicated lighting. Others are used for assisting visibility in hard-to-reach places like under vehicles. These devices are especially useful in the event of external power loss.

It is an object of this invention to provide an improved portable lighting solution that can be carried by a user to provide light in the area they are working as needed.

It is a further object of this invention to provide an improved portable lighting solution with a longer lasting power source.

It is a further object of this invention to provide an improved portable lighting solution that is dust and water resistant.

### SUMMARY OF THE INVENTION

The present disclosure provides a lighting device which includes a lighting element positioned in a housing and a battery system coupled to an inside of the housing and operably connected to and enabling the lighting element to emit light. The lighting device includes a first phosphorescent element which is positioned to absorb light from an ambient light source, the lighting element, or both. The first phosphorescent element therefore enables the lighting device to be located in dark.

The present disclosure provides a lighting device which includes a lighting element positioned in a housing and a battery system coupled to an inside of the housing and operably connected to and enabling the lighting element to emit light. The lighting device includes one or more phosphorescent elements arranged to absorb a portion of the light emitted from the lighting element. At least one of the phosphorescent elements is capable of receiving light from an ambient light source such that the first phosphorescent element enables the lighting device to be located in dark.

The present disclosure provides a method of using a lighting device. The lighting device which includes a lighting element positioned in a housing and a battery system coupled to an inside of the housing and operably connected to and enabling the lighting element to emit light. The lighting device includes a first phosphorescent element which is positioned to absorb light from an ambient light source, the lighting element, or both. The first phosphorescent element therefore enables the lighting device to be located in dark. The method of using this device includes engaging the lighting element in the housing of the light to provide luminescence. The lighting device charges the phosphorescent element in the housing with the luminescence or the ambient light. The lighting element is disengaged or the ambient light is removed and the user locates the lighting device by the light emitted by the phosphorescent element.

### BRIEF DESCRIPTION OF THE DRAWINGS

FIG. 1 is a perspective view of a multi-functional light in a handheld configuration according to the teachings of this invention.

FIG. 2 is a top perspective view of the multi-functional light of FIG. 1.

FIG. 3 is a bottom perspective view of the multi-functional light of FIG. 1.

FIG. 4 is a perspective view of the multi-functional light of FIG. 1, shown in a folded position.

FIG. 5 is a perspective view of a multi-functional light in a stationary configuration according to this invention.

FIG. 6 is a rearward perspective view of the multi-functional light of FIG. 5.

FIG. 7 is a perspective view of a multi-functional light in a configuration according to this invention.

FIG. 8 is a back view of the multi-functional light of FIG. 5.

FIG. 9 is a perspective view of a multi-functional light in a detachable wand configuration according to the teachings of this invention.

FIG. 10 is a perspective view of the handheld unit detached from the multi-functional light of FIG. 9.

FIG. 11 is a perspective view of a multi-functional light in an extensible, detachable configuration according to this invention.

FIG. 12 is a perspective view of the handheld unit detached from the multi-functional light of FIG. 11.

### DETAILED DESCRIPTION OF THE INVENTION

The following description of example methods and apparatus is not intended to limit the scope of the description to the precise form or forms detailed herein. Instead the following description is intended to be illustrative so that others may follow its teachings.

The terms “light emitting diode” and “LED” are also used in the following description. One of ordinary skill will appreciate that an LED describes a wide variety of two lead semiconductors that emit light by electroluminescence when a voltage differential is applied. LED lights can be in variety of sizes and typically come in either through-hole or surface mount configurations.

The term “phosphorescence” is also used in the following description. Phosphorescence refers to a mechanism by which a material fluoresces when exposed to radiation. This mechanism is associated with unsuitable energy state transitions in quantum mechanics. A phosphorescence material does not immediately re-emit the radiation it absorbs, but instead absorbed radiation is re-emitted at a lower intensity for up to several hours after the original excitation.

In the following description, the terms “water resistant” or “dust resistant” are used. These terms are set under ANSI/IEC-60529 which promulgates certain standards for the degrees of protection granted against intrusion by both solid objects and water. Solid objections include dust, debris, and even accidental conduct by the user's body during use. The terms “water resistant” or “dust resistant” on their own do not necessarily mean that no dust or no water will enter the device.

A portion of the surface on which the one or more LEDs are mounted may be coated with a photo-luminescent (e.g., fluorescent or phosphorescent) substance that absorbs light—either from the environment and/or from the one or more LEDs—that glows for a duration of time after being removed from the bright environment and/or after the LEDs have been turned off. The light emitted from the phosphorescent substance, although dimmer than the LED light, allows the lighting device to be located in dark environments.

In an example scenario, a mechanic is servicing an automobile engine in a dark or inadequately lit environment. Due to the poor lighting conditions, it is difficult for the mechanic to see the components in the engine bay. The mechanic then locates the multi-functional lighting device from the glow of its phosphorescent surface. Using the example multi-functional lighting device, the mechanic adjusts the length of the rods and orients the hooks so that the lighting device can be hung from the underside of the elevated car hood. By pointing the LEDs downward, the mechanic can illuminate the engine bay, without having to hold a flashlight in one hand while working. If a region within the engine bay is obscured by other engine components, the mechanic can remove the foldable lighting device from the receptacle and manually orient it to illuminate the otherwise dark region.

The example multi-functional lighting device may be powered via replaceable or rechargeable batteries. In some instances, the multi-functional lighting device includes a charging port into which a connector of a power source can be inserted to supply power to rechargeable batteries of the multi-functional lighting device. In other instances, the multi-functional lighting device includes a receptacle with conductive contacts into which one or more batteries may be inserted for powering the multi-functional lighting device.

In another example situation, when additional lighting is needed as in a power outage or repair task, the consumer removes the flashlight and twists the switch to activate the light. A rotatable focus allows the user to narrow the beam. After the use is finished, the user can twist the head unit housing to reveal the charging port. Access unopposed, the user may engage the plug and restore power to the device.

Referring now to the figures, a variety of implementations for the multi-functional lighting device 10 are shown in a variety of forms. In each case, the multi-functional light uses an LED lighting element for the purposes of illumination. LEDs may include any combination of LED types and/or colors. In some instances, it may be desirable to have a particular LED color (or combination of colors) to accomplish a certain illumination goal. For example, it may be preferable to use white LEDs (i.e., light emitting diodes with a phosphor coating that is excited by monochromatic light to produce a spectrum of wavelengths) to achieve a broad spectrum of absorption. As another example, it may be desirable to use ultra-violet (UV) LEDs, to excite fluorescent dyes or otherwise illuminate UV-reactive substances. One of ordinary skill would appreciate the benefits of using different LED colors in various applications.

Surrounding the lighting element is a phosphorescent element which allows the ambient light or light from the lighting element to emit light onto the surface of the phosphorescent element. The light from the lighting element shines on the phosphorescent ring and is absorbed by the molecular structure. As the light is released more slowly than it is absorbed, the phosphorescent ring will glow even after the lighting element is turned off. In various implementations of this disclosure, the phosphorescent element is positioned in ways to be charged by the lighting element or ambient light. Some embodiments also contain a second phosphorescent element positioned on another portion of the body of the multi-functional light.

The lighting element is contained in the housing. The housing is hollow and serves to protect the internal components of the flashlight and provide structure to the device as a whole. The housing in the example flashlight is made of a hard plastic material. In other examples, the housing is made of metal or any suitable stiff material that can support the other components of the flashlight.

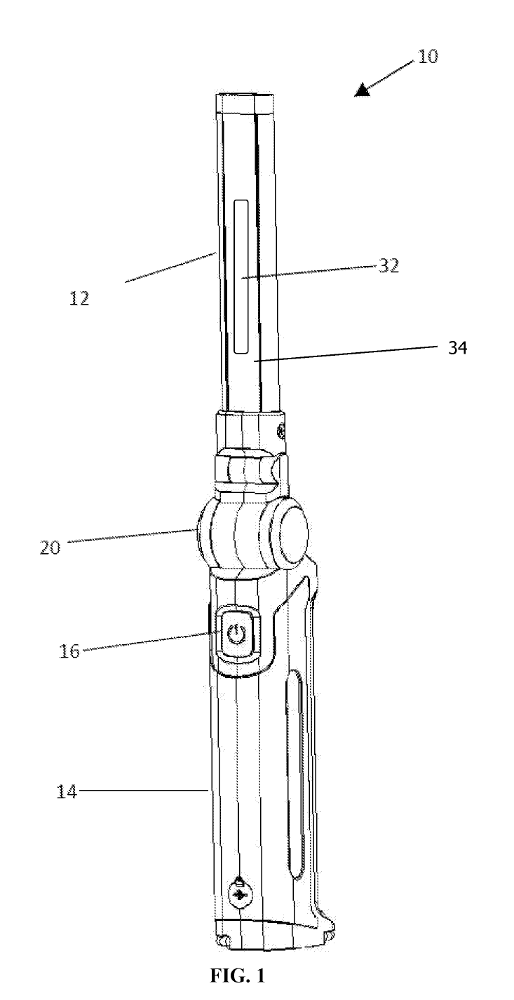

Referring now to FIGS. 1-3, an example of a multi-functional lighting device is shown as portable lighting device 10 with a foldable thin light wand or extension 12 shown. The extension 12 is connected to a base 14 by a hinge 20 as shown in the example portable lighting device 10 in FIG. 1. Rear portions of the extension 12 are made of aluminum to form a rear housing of the light wand for heat dissipation and impact resistance.

The hinge 20 in the example portable lighting device can rotate a full 180° from the extended position shown in FIGS. 1-3 to a folded position. The extension 12 is equipped with a pivot that allows it to rotate about its vertical center axis to any angle.

The extension 12 supports a high efficiency COB forward LED 32 used to illuminate as shown in FIG. 1. The forward LED 32 is a high color rendition index chips on board LED. A reflector 34 is positioned around the LED 32 to better direct the light away from the device and into the surroundings. It is contemplated that other light emitting technologies can be used in place of LED 32 including techniques such as arc, incandescent, and florescent bulbs. The reflector 34 also includes a phosphorescence material which can make it easier to find the portable lighting device 10 in the dark, especially if the device is accidentally turned off. In this example, reflector 34 with a phosphorescent element functions as the phosphorescent element charged by the lighting element 32.

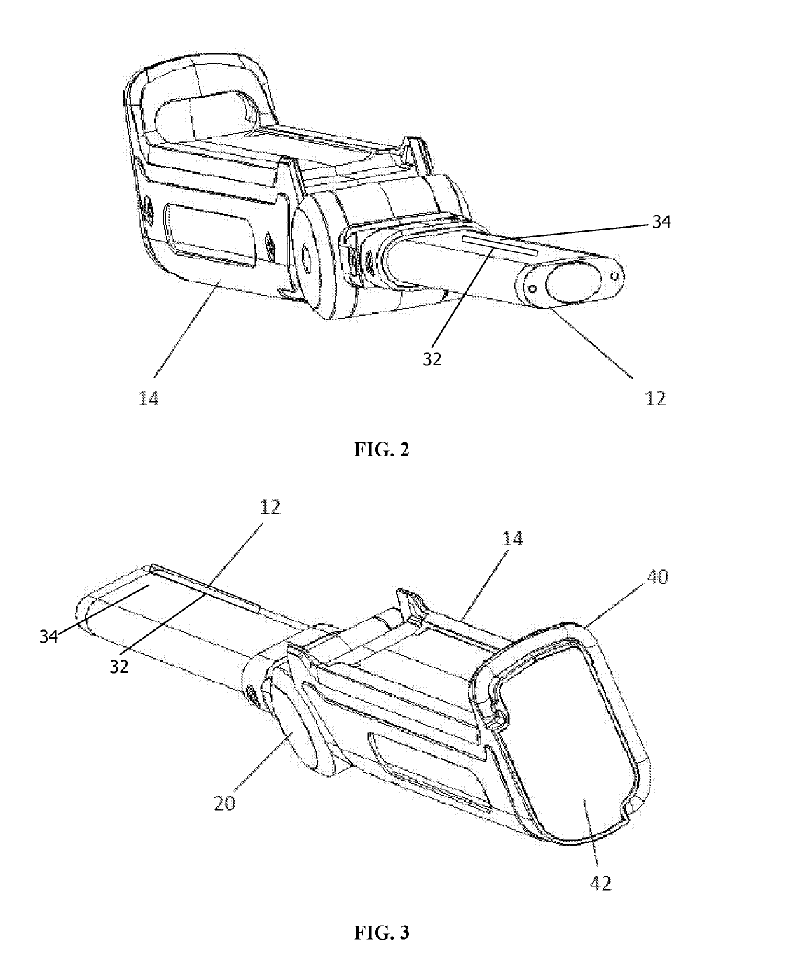

Another LED, a spotlight 50, is positioned at the top of the extension 12 as shown in FIG. 2. The spotlight 50 is also surrounded by a total reflector 52. The top spotlight 50 on the extension 12 uses a hot melt technique in construction to achieve this. The spotlight 50 is a high power surface mounted LED light that can be used as a conventional flashlight when the portable lighting device 10 is extended.

The base portion 14 contains a lithium-ion rechargeable battery to provide power to the rest of the device. The base portion 14 also has a charging indicator 26 built into design and a switch 16 for activating and deactivating the device. The example portable lighting device 10 contains a lithium-ion battery, but could also include another cell or series of cells rechargeable, such as those made of nickel cadmium, or alternatively a single use, non-rechargeable battery, such as those made of alkaline. One of ordinary skill in the art will appreciate that internal components in the portable lighting device 10 also contain charging and discharging circuits, heat sinks, and other electronic components.

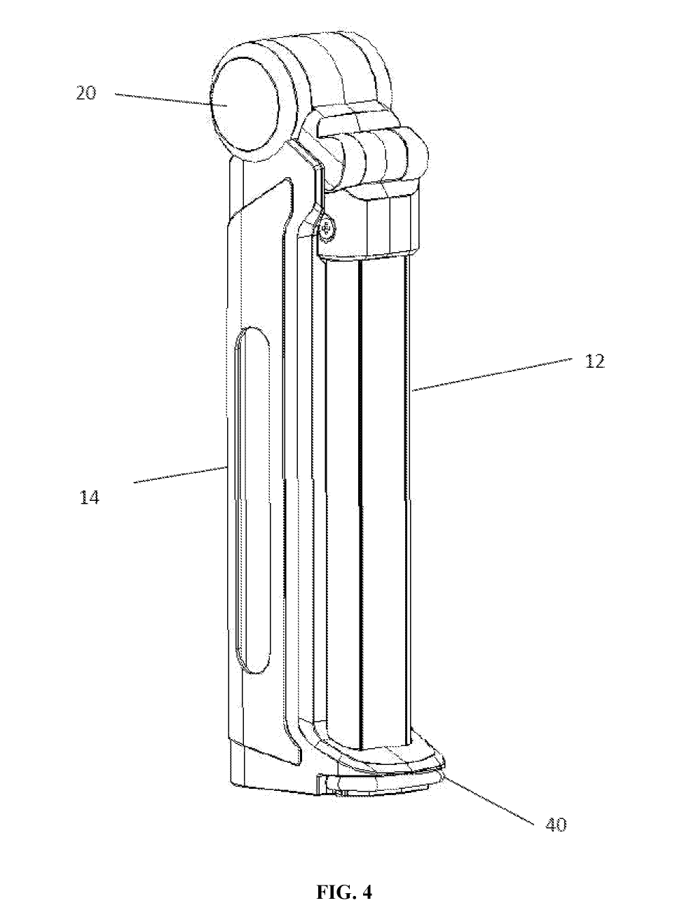

A magnetic bottom 42, as shown in FIG. 3, can support the portable lighting device 10 on a variety of surfaces, including on walls or other non-standard surfaces. A rotatable hanging hook 40 is hingedly attached to and can extend out from the base portion 14 in order to hang the device from any perch. For example, the hook 40 could be used to hang the portable lighting device 10 from a car frame, table, or any other location where the user needs hands-free light provided.

In use, the extension 12 is a light wand that can pivot +180° and −180° for easy handling and storage. This portable lighting device 10 has an ultra-thin design that pivots and folds flat to allow inspection in the tightest work areas. The strong construction design of base portion 14 allows product to drop safely from up to 1.5 meters. The design of portable lighting device 10 prevents contact and the ingress of dust of more than a de minimis amount that provides no harm to the function of the device. It is also shielded from splashing water such that incidental contact with but not submersion in water.

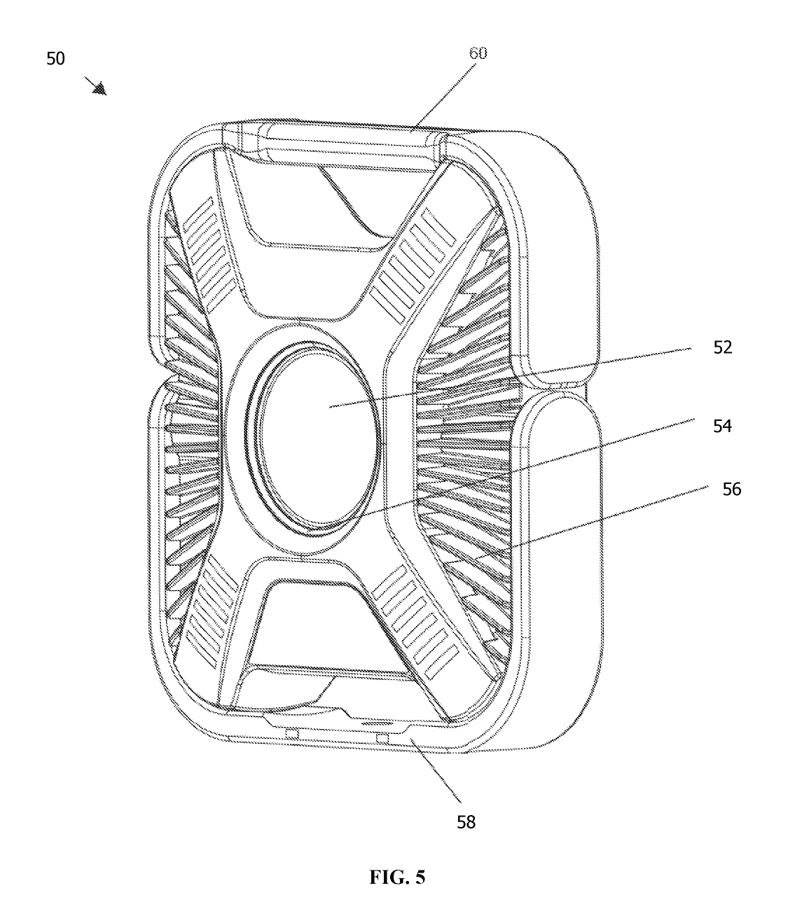

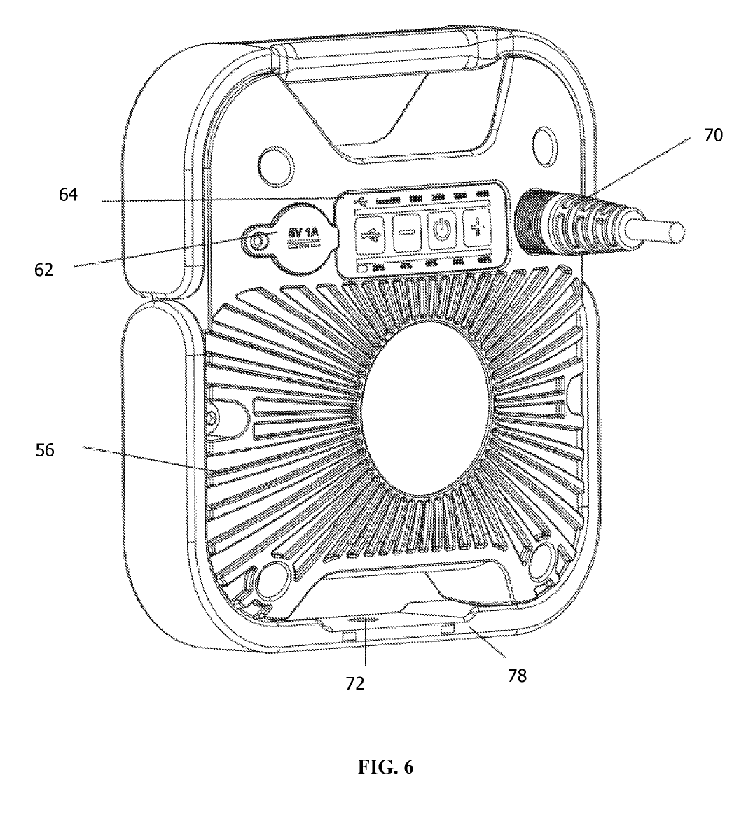

Referring now to FIGS. 5-6, another example of the multi-functional lighting device is shown as portable lighting device 50 shown. In the example portable lighting device 50, the housing 56 is shaped in an “x” or cross configuration and has a rotating support bracket 58, shown extended in FIG. 2. This example configuration efficiently distributes the material to maximize strength while minimizing material usage and costs.

The housing 56 is an aluminum finned design extending across large portions of the front and back of the device as shown in FIGS. 5 and 6. The housing 56 is constructed of high quality aluminum, and the fins are designed for heat dissipation and impact resistance. The configuration is a strong construction design that allows product to drop safely from two meters.

The front face of the portable lighting device 50 includes a high efficiency chip on board (“COB”) forward LED 52 used to illuminate, as shown in FIG. 5. A borosilicate glass lens protects the forward LED 52 in the example portable lighting device shown. The forward LED 52 is a high color rendition index chips on board LED. A reflector 54 is positioned around the LED 12 to better direct the light away from the device. It is contemplated that other light emitting technologies can be used in place of LED 52 including techniques such as arc, incandescent, and florescent bulbs. The reflector 54 is also a phosphorescent material which can make it easier to find the portable lighting device 50 in the dark, especially if the device is accidentally turned off. In this example, reflector 54 functions as the phosphorescent element charged by the lighting element.

In the rear view shown in FIG. 6, a control panel 64 is shown. This control panel shows a variety of controls and displays. In the example shown in FIG. 5, there is a switch for activating the device and dimmer controls for adjusting the brightness of the forward LED 52. In addition to brightness control, the system can adjust the color temperature of the forward LED 52 allowing the user to select a calming yellow-white light, a clean blue-white. This luminous flux adjustment by dimmer controls can be accomplished manually or by Bluetooth control by a user device, such as a cell phone or tablet for use of the dimmer function. In this example, the portable lighting device 50 will contain a wireless transceiver for Bluetooth communication with a user device. One of ordinary skill in the art will understand that the transceiver can be used or adapted for a wide range of wireless technologies such as WiFi, WiLAN, or any other suitable means of communication.

The portable lighting device 50 contains a lithium-ion rechargeable battery to provide power to the rest of the device. A charging port 52 is shown on the back of lighting device 50. This enables an “R+C system,” where R is “rechargeable” and C is “cable”. The product can be charged as a DC type unit, using the lithium-ion battery, but it also can be used with the cable hooked into external power as a conventional AC type electrical device.

As shown in FIGS. 5-6, the example portable lighting device also includes a handle 60 and the rotating support bracket 58. The handle makes the portable lighting device 50 more easily carried. The rotating support bracket 58 has a mounting point 72 which allows the portable lighting device to be affixed to a tripod or other accessories. The rotating support bracket 58 can serve as a leg or stand alone, or as a pivot when the portable lighting device 50 is mounted.

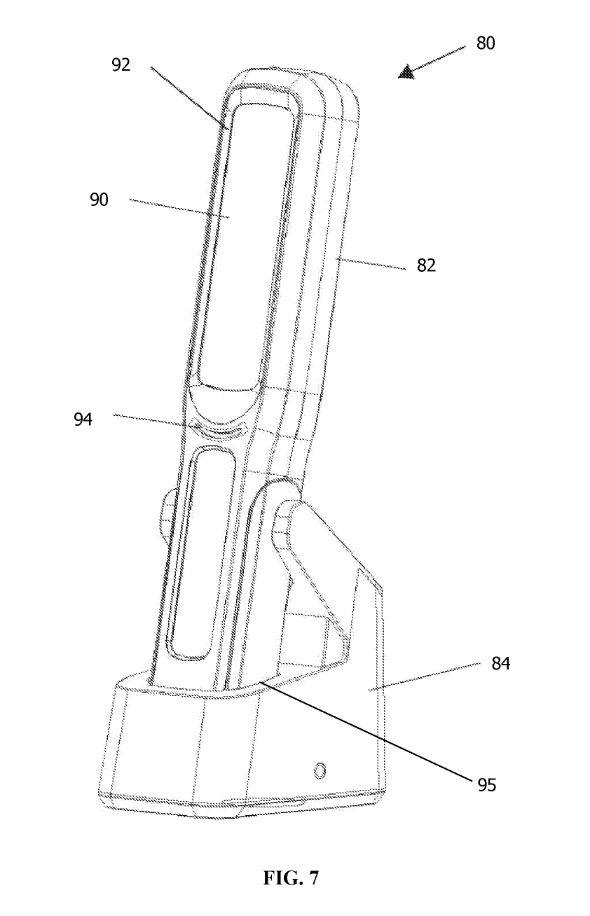

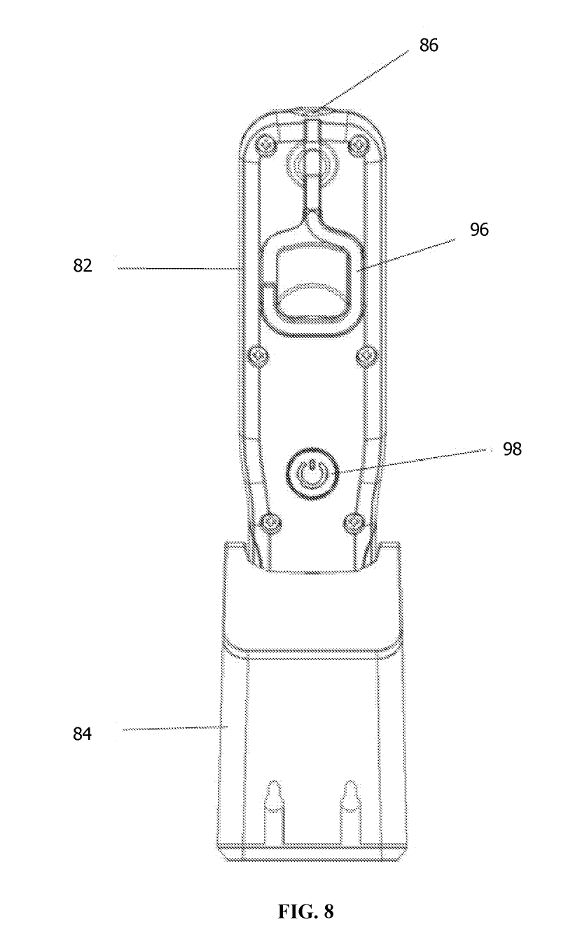

Referring now to FIGS. 7-8, a still further example of the multi-functional lighting device is shown as lamp 82 and base 84. Lamp 82 sits on the charging base 84 as shown in FIG. 7. Lamp 82 is a solidly constructed light wand with light emitters built into the top and front faces and further containing a lithium ion battery. The lamp 82 also has a charging indicator 94 on the front face. This indicator is a series of LEDs in the shown example. One of ordinary skill in the art would be able to adapt the indicator with other suitable means such as a color changing LED. A switch 96 is included on the rear side of the lamp 82.

The front light emitter on lamp 82 supports a high efficiency COB forward LED 90 used to illuminate surroundings as shown in FIG. 2. The forward LED 90 is a high color rendition index chips on board LED. A reflector 92 is positioned around the LED 90 to better direct the light away from the device. It is contemplated that other light emitting technologies can be used in place of LED 90 including techniques such as arc, incandescent, and florescent bulbs. The reflector 92 is a florescent material which can make it easier to find the lamp 82 in the dark, especially if the device is accidentally turned off. In this example, reflector 92 functions as the phosphorescent element charged by the lighting element.

Another light emitter, a spotlight 86, is positioned at the top of the lamp 82 as shown in FIG. 3. The spotlight 86 is also surrounded by a total reflector. The spotlight 86 is a high power surface mounted LED light that can be used as a conventional flashlight when the portable lighting device 80 is extended.

The base portion that comprises charging base 84 includes a charging socket 95 in order to connect the base 84 to external power as shown in FIG. 7. A charging interface (not shown) on the lamp 82, respectively, are used to ensure a secure and fast connection to between the two parts.

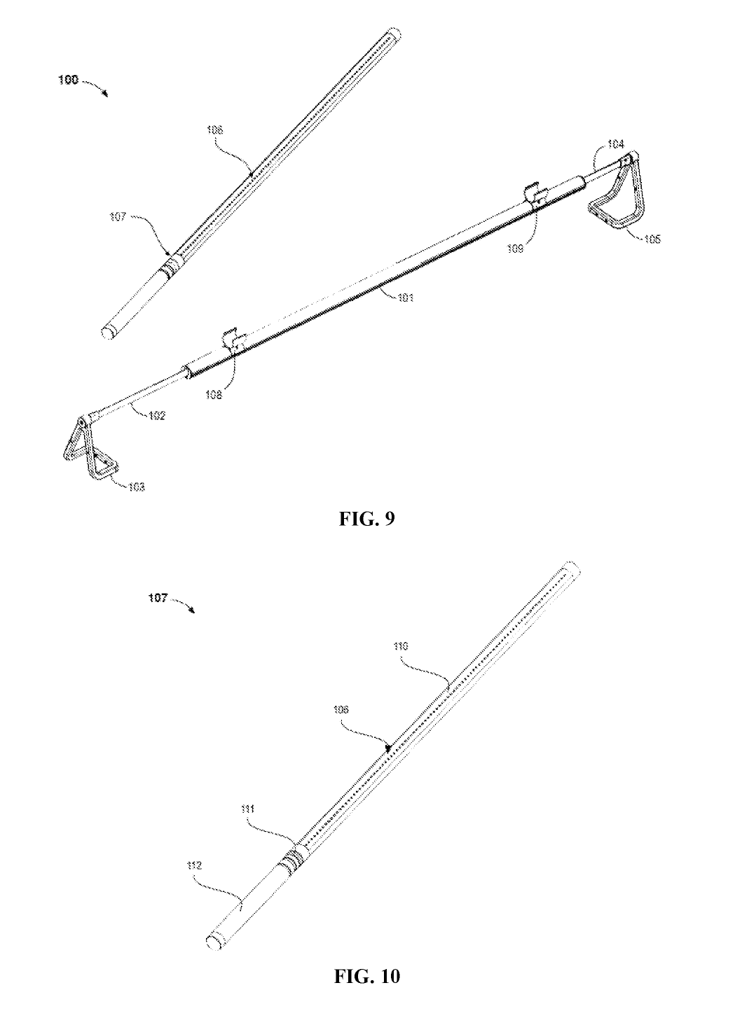

Referring now to FIGS. 9-10, another example of the multi-functional lighting device is shown as separable multi-functional lighting apparatus 100. A separable multi-functional lighting apparatus 100 includes an elongated housing 101 with rods 102 and 104 extending coaxially from the ends of the elongated housing 101. The elongated housing 101 includes clips 108 and 109 into which the detachable lighting apparatus 107 is removably secured. A surface of the detachable lighting apparatus 107 includes an illuminated region with LEDs 106 and photo-luminescent or phosphorescent material surrounding LEDs 106.

As shown in FIG. 10, the detachable lighting apparatus 107 includes LEDs 106 surrounded by a photo-luminescent region 110 which is phosphorescent. In some examples, the LEDs and photo-luminescent region 110 may be covered by a transparent or translucent cover, such as glass or plastic, to protect the LEDs 106 and photo-luminescent region 110. The detachable lighting apparatus 107 also includes a magnetic rotary switch 111 for turning the LEDs 106 on and off. The magnetic rotary switch 111 may be cylindrical in shape and, in some implementations, is approximately the same diameter as that of the detachable lighting apparatus 107.

Rods 102 and 104 may be independently movable, such that rod 102 may be extended by a first amount, while rod 104 is extended by a different amount. Such independent movability may permit the multi-functional lighting apparatus 100 to be hooked or attached to an object, while selectively placing the light more to one side than the other. For example, if multi-functional lighting apparatus 100 is hooked on the underside of the hood of an automobile, one of rods 102 and 104 may be extended more than the other to place the LEDs 106 over a specific portion of the engine bay, rather than being centered over the engine bay.

respectively. In some embodiments, hooks 103 and 105 are curved or angled features at the distal ends of rods 102 and 104. In other embodiments, hooks 103 and 105 are separate elements coupled to the distal ends of rods 102 and 104. The hooks 103 and 105 may be removably coupled to the rods 102 and 104, allowing the hooks 103 and 105 to be removed and replaced with other hooks. In some embodiments, the hooks 103 and 105 may be rotatably coupled to the distal ends of rods 102 and 104, such that the elongated housing 101 and LEDs 106 mounted thereon can be oriented without rotating rods 102 and 104; such rotatably coupled hooks 103 and 105 allow for implementations with rods 102 and 104 having non-symmetrical shapes.

The detachable lighting apparatus 107 may be substantially cylindrical in shape, and include LEDs 106 mounted on one of its surfaces. The surface on which the LEDs 106 are mounted may also be coated with a phosphorescent and photo-luminescent substance 110, which may provide a faint glow even when LEDs 106 are turned off. The detachable lighting apparatus 107 may include proximal and distal regions without LEDs. These regions may be used to store batteries, circuitry for driving the LEDs, and control circuitry for turning the LEDs on and off. These regions may also serve as handles or grips when the detachable lighting apparatus 107 is used separately from the multi-functional lighting apparatus 100. The detachable lighting apparatus 107 may also include thereon switches, buttons, or other control interface for operating the detachable lighting apparatus 107 (e.g., turning the LEDs on and off, adjusting LED brightness, switching the operation mode of the LEDs, etc.).

Referring now to FIGS. 10, a multi-functional lighting apparatus 100 includes an elongated housing 101 with rods 102 and 104 extending coaxially from the ends of the elongated housing 101. A surface of the elongated housing 101 includes an illuminated region with LEDs 106 and phosphorescent and photo-luminescent material surrounding LEDs 106. The elongated housing 101 includes a receptacle 113 in which removable lighting apparatus 108 can be removably secured. An end of the housing has thereon a charging port 109 into which a charging cable can be removably secured. The charging port 109 may serve to supply power to the LEDs 106 and removable lighting apparatus 108, and to charge any batteries or other energy storage elements included within the multi-functional lighting apparatus 100 and/or removable lighting apparatus 108.

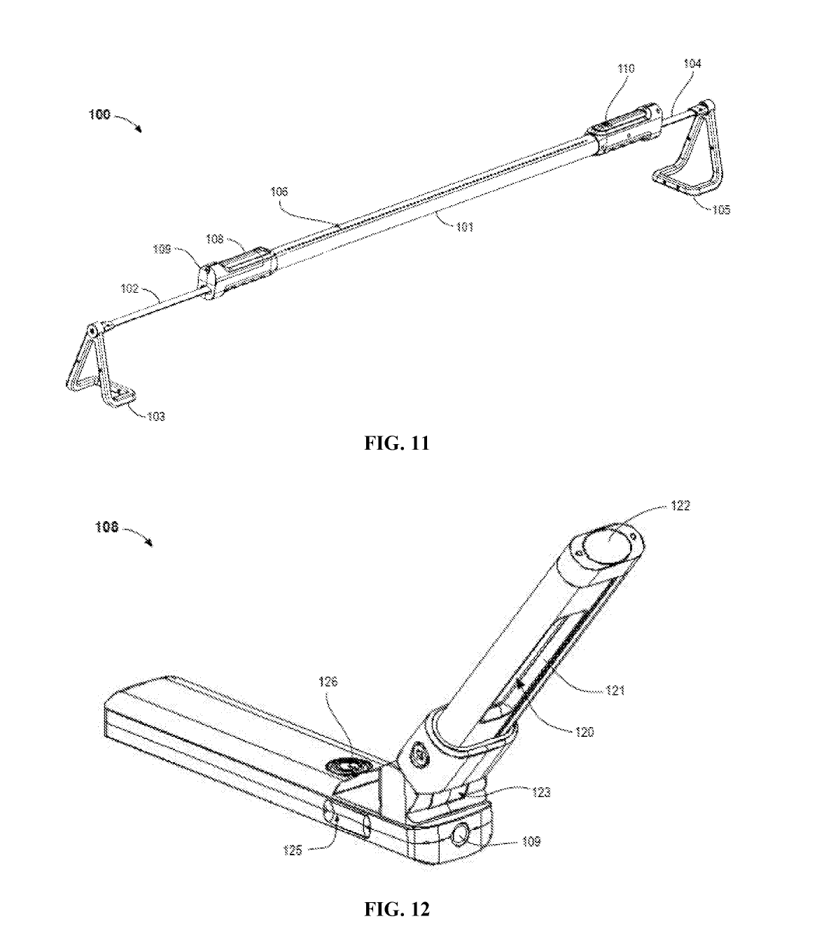

Referring now to FIGS. 11-12, another example of the multi-functional lighting device is shown as multi-functional lighting apparatus 100. The multi-functional lighting apparatus 100 includes an elongated housing 101 with rods 102 and 104 extending coaxially from the ends of the elongated housing 101. A surface of the elongated housing 101 includes an illuminated region with LEDs 106 and photo-luminescent material surrounding LEDs 106. The elongated housing 101 includes a receptacle 113 in which removable lighting apparatus 108 can be removably secured. An end of the housing has thereon a charging port 109 into which a charging cable can be removably secured. The charging port 109 may serve to supply power to the LEDs 106 and removable lighting apparatus 108, and to charge any batteries or other energy storage elements included within the multi-functional lighting apparatus 100 and/or removable lighting apparatus 108. Rods 102 and 104 may be independently movable, as described above with respect to FIGS. 9-10.

The removable lighting apparatus 108 includes a base 124 and a rotatable member connected to each other through hinge 123. The rotatable member may include LEDs 120 and a photo-luminescent region 121 in a recessed portion of the rotatable member. On the end of the rotatable member opposite from the hinge 123, a light emitting region 122 is provided that includes one or more LEDs (e.g., high power SMD LEDs) surrounded by reflective or photo-luminescent surfaces. The surface surrounding the LED(s) in light emitting region 122 may be shaped like a total reflection spotlight lens, and can be formed using a hot-melt technique. The rotatable member may include an aluminum housing for heat dissipation and impact resistance.

The LEDs 120 may be either SMD LEDs or chips on board (COB) LEDs. The COB LEDs may provide a continuous diffused light source that outputs a more even illumination compared to SMD LEDs. The photo-luminescent region 121 may include fluorescent or phosphorescent substances that glow or otherwise emit light in addition to the LEDs 120.

Although certain example methods and apparatuses have been described herein, the scope of coverage of this patent is not limited thereto. On the contrary, this patent covers all methods, apparatuses, and articles of manufacture fairly falling within the scope of the appended claims either literally or under the doctrine of equivalents.

What is claimed is:

1. A lighting device, comprising:
a lighting element positioned in a housing;
a battery system coupled to an inside of the housing and operably connected to and enabling the lighting element to emit light; and
a first phosphorescent element positioned to absorb light from an ambient light source, the lighting element, or both, wherein the first phosphorescent element enables the lighting device to be located in dark.

2. The lighting device of claim 1, wherein a portion of the first phosphorescent element is positioned to receive light emitted directly from the lighting element.

3. The lighting device of claim 1, wherein the first phosphorescent element is positioned substantially circumferentially around the lighting element.

4. The lighting device of claim 1, wherein the first phosphorescent element is positioned in an elongated shape around the lighting element.

5. The lighting device of claim 1, further comprising a second phosphorescent element positioned on a removed area of the housing.

6. The lighting device of claim 1, further comprising a strap adapted to affix the light to a body part of a user.

7. The lighting device of claim 1, further comprising a hook adapted to hang the light.

8. The lighting device of claim 1, further comprising a magnetic portion adapted to secure the device to a metallic surface.

9. The lighting device of claim 1, further comprising a switch for controlling the lighting element connected with the battery system to emit light.

10. The lighting device of claim 1, further comprising a flexible extension to variably orient the lighting element, the flexible extension including a flexible connection of the lighting element to the battery system.

11. A lighting device, comprising:
a lighting element positioned in a housing;
a battery system coupled to an inside of the housing and operably connected to and enabling the lighting element to emit light; and
one or more phosphorescent elements arranged to absorb a portion of the light emitted from the lighting element;
wherein at least one of the phosphorescent elements is capable of receiving light from an ambient light source such that the first phosphorescent element enables the lighting device to be located in dark.

12. The lighting device of claim 11, wherein a portion of at least one of the phosphorescent elements is positioned to receive light emitted directly from the lighting element.

13. The lighting device of claim 11, wherein of at least one of the one of the phosphorescent elements is positioned substantially circumferentially around the lighting element.

14. The lighting device of claim 11, wherein at least one of the phosphorescent elements is positioned in an elongated shape around the lighting element.

15. The lighting device of claim 11, wherein at least one of the phosphorescent elements is positioned in a first region of the housing and further comprising a second phosphorescent element positioned in a second region of the housing.

16. A method of using a lighting device, where the lighting device comprises:
a lighting element positioned in a housing;
a battery system coupled to an inside of the housing and operably connected to and enabling the lighting element to emit light; and
a first phosphorescent element positioned to absorb light from an ambient light source, the lighting element, or both;
wherein the method of using the lighting device comprises:
engaging the lighting element in the housing of the light to provide luminescence;
charging the phosphorescent element in the housing with the luminescence or the ambient light;
disengaging the lighting element or removing the ambient light; and
locating the lighting device in the dark by the light emitted from the phosphorescent element.
